(19) United States
(12) Patent Application Publication
(10) Pub. No.: US 2004/0194666 A1
(43) Pub. Date: Oct. 7, 2004

(54) Pigment compositions for coatings

(76) Inventor: Shivakumar Basalingappa Hendi, Newark, DE (US)

Correspondence Address: JoAnn Villamizar, Patent Department, Ciba Specialty Chemicals Corporation, 540 White Plains Road, P.O. Box 2005, Tarrytown, NY, 10591-9005, US

(21) Appl. No.: 10/812,278

(22) Filed: Mar. 29, 2004

Related U.S. Application Data
(60) Provisional application No. 60/459,836, filed on Apr. 2, 2003.

(51) Int. Cl. C04B 2/00

(52) U.S. Cl. 106/499; 106/493; 106/494; 106/495; 106/415; 106/417

(57) ABSTRACT

The present invention relates to pigment and coating compositions that are used to prepare pigmented coatings that exhibit geometric metamerism or metallic flop. The inventive pigment compositions comprise a small particle size pigment, at least one flop-enhancing agent, optionally one or more pigment property enhancing compounds. The flop-enhancing agent is selected from the group consisting of a halogenated copper phthalocyanines, indanthrones or carbazole dioxazines or mixtures thereof that are unsubstituted or substituted in the benzene rings by halogen, —NR₁R₂, C₁-C₁₀alkyl and —X—NR_{1′}R_{2′}, wherein R₁ and R₂ are independently hydrogen, C₁-C₁₀alkyl or —X—NR_{1′}R_{2′}, R_{1′} and R_{2′} are independently hydrogen or C₁-C₁₀alkyl, and X is C₁-C₁₀alkylene. The pigment property enhancing compounds may be a texture improving agent, a rheology improving agent, an antiflocculating compound and a dispersibility improving compound. A method of enhancing the flop of a pigmented polymeric coating by incorporating one or more flop-enhancing agents into the composition is also disclosed. The coating compositions comprise the inventive pigment composition and an effect pigment.

This application claims the benefit of U.S. Provisional Application No. 60/459,836, filed Apr. 2, 2003.

### SUMMARY OF THE INVENTION

The invention relates to pigment compositions which are useful for preparing polymeric coatings having a metallic flop.

The present invention relates to pigment compositions and coating compositions that are used to prepare pigmented coatings that exhibit geometric metamerism or metallic flop, that is, hue of the coating changes based on the viewing angle of the observer. The invention is based on the general discovery that the flop of a pigmented coating is greatly enhanced if it is colored with a pigment composition that contains a small particle size pigment that is treated with a small amount of a halogenated copper phthalocyanine, indanthrone or carbazole dioxazine compound which acts as a flop-enhancing agent.

### BACKGROUND

The use of small particle size pigments as transparent pigments in coating compositions is well known in the art. Coating compositions containing transparent pigments are useful for automotive and industrial finishes.

Copper phthalocyanine, indanthrone and carbazole dioxazine compounds are also well known in the art, primarily as pigments or as dyes.

U.S. Pat. No. 5,362,780 describes pigment compositions containing a 2,9-dichloroquinacridone and a blue-colored copper phthalocyanine sulfonic acid or indanthrone sulfonic acid. The copper phthalocyanine and indanthrone sulfonic acids are utilized to adjust the color of the magenta 2,9-dichloroquinacridone pigment in order to obtain a heat-stable violet pigment which is used for coloring engineering plastics. The compositions in the '780 patent are not utilized in coating compositions, and there is no suggestion that the copper phthalocyanine and indanthrone sulfonic acids could enhance the flop of pigmented coatings.

U.S. Pat. No. 5,618,343 describes pigment compositions with an unprecedented flop-effect using certain copper phthalocyanine sulfonic acid pigment. Surface modification of small particle size pigments with minute amounts of copper phthalocyanine sulfonic acid produces pigments with unusual flop-effect. Although the pigments produce unique automotive colors, the pigments containing copper phthalocyanine sulfonic acid were found to be unsuitable for automotive applications. The pigments lack the outdoor durability essential for automotive stylings.

Surprisingly it has been discovered that surface modification of transparent pigments with a copper phthalocyanine green pigment produces pigments capable of creating the desirable flop-effect, and the pigments showed durability characteristics required for automotive colors.

From a color design point of view, one skilled in the art would have predicted a brown color from the combination of a green pigment with a red pigment. Therefore this result is very interesting and could not have been expected. Further the durability enhancements derived from the present invention are totally unexpected, making this discovery commercially significant. The pigment compositions of the present invention are suitable as automotive colors.

According to the present invention, a pigment composition containing a small particle size pigment and a flop-enhancing agent is utilized to pigment a coating composition. The pigmented coatings prepared from such coating compositions exhibit a high degree of flop and excellent outdoor durability. The present invention represents an improvement in the art that permits access to new color space regions for automotive stylings.

### DETAILED DESCRIPTION OF THE INENTION

The present invention relates to a pigment composition, which comprises a small particle size pigment and at least one flop-enhancing agent, which flop-enhancing agent is a halogenated copper phthalocyanine, an indanthrone or a carbazole dioxazine compound. The present invention further relates to coating compositions that are pigmented with a tinctorally effective amount of a pigment composition which comprises a small particle size pigment and a flop-enhancing agent. The invention also relates to method of enhancing the flop of a pigmented coating by incorporating one or more flop-enhancing agents into the composition.

The expression “flop” is used to describe a phenomenon whereby different hues are observed from different viewing angles (also known as “goniochromaticity”).

The flop-enhancing agent utilized in the pigment compositions of the present invention are halogenated copper phthalocyanine, indanthrone and carbazole dioxazine compounds; including derivatives thereof, especially chloro, bromo derivatives of copper phthalocyanine, and chloro, bromo, sulfonamido, alkyl, alkoxy, alkylamino and dialkylamino derivatives of indnathrone and carbazole dioxazine compounds, especially copper phthalocyanine containing multiple halogen groups such as Pigment Green 7 and Pigment Green 36 type compounds:

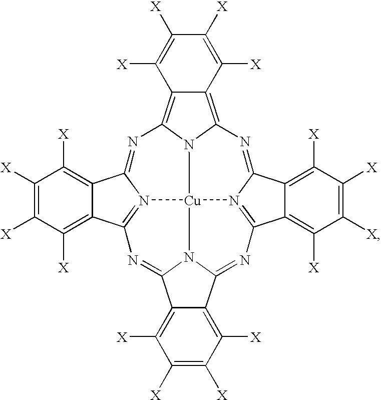

wherein each X is independently from the others H, Cl or Br; (Pigment Green 7=usually C₃₂H₃N₈Cl₁₃Cu−C₃₂HN₈Cl₁₅Cu; Pigment Green 36=usually C₃₂HN₈Cl₂Br₁₃Cu−C₃₂HN₈Cl₇Br₈Cu).

Particularly suitable copper phthalocyanine compounds are of the formula C₃₂H_{X}N₈Cl_{Y}Br_{Z}Cu, wherein x is 0 to 4, y is 0 to 16, and z is 0 to 16; and wherein the benzene rings are substituted by one or more substituents selected from the group consisting of halogen, —NR₁R₂, C₁-C₁₀alkyl and —X—NR_{1′}R_{2′}, wherein R₁ and R₂ are independently hydrogen, C₁-C₁₀alkyl or —X—NR_{1′}R_{2′}, R_{1′} and R₂′ are independently hydrogen or C₁-C₁₀alkyl, and X is C₁-C₁₀alkylene.

Throughout the application, C₁-C₁₀alkyl and C₁-C₁₀alkylene may be linear, cyclic or branched and are preferably C₁-C₆ alkyl and C₁-C₆alkylene, respectively. C₃-C₁₀alkyl and C₃-C₁₀alkylene are preferably branched on one carbon atom, especially with a C₁-C₆ alkyl or C₁-C₆alkylene primary chain and a C₁-C₄alkyl secondary chain bound to the branching carbon atom. In NR₁R₂ and/or NR_{1′}R_{2′}, R₁ and R₂ may form a ring together.

Preferred copper phthalocyanine flop-enhancing agents include tetra-chlorinated copper phthalocyanine and copper phthalocyanine compounds which are substituted by four or more halogen substituents and one or more substituents selected from the group consisting of —NR₁R₂, C₁-C₁₀alkyl and —X—NR_{1′}R_{2′}, wherein R₁ and R₂ are independently hydrogen, C₁-C₁₀alkyl or —X—NR_{1′}R_{2′}, R_{1′} and R_{2′} are independently hydrogen or C₁-C₁₀alkyl, and X is C₁-C₁₀alkylene.

Particularly suitable indanthrone compounds include compounds of the formula

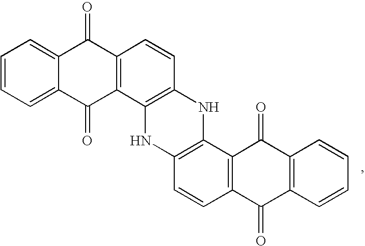

wherein the benzene rings are unsubstituted or substituted by one or more substituents selected from the group consisting of halogen, —NR₁R₂, C₁-C₁₀ alkyl and —X—NR_{1′}R_{2′}, wherein R₁ and R₂ are independently hydrogen, C₁-C₁₀alkyl or —X—NR_{1′}R_{2′}, R_{1′} and R_{2′} are independently hydrogen or C₁-C₁₀alkyl, and X is C₁-C₁₀alkylene.

Preferably, the benzene rings are unsubstituted or substituted by 1 to 4 substituents. Most preferably the benzene rings are unsubstituted or substituted by one or two substituents.

Preferred indanthrone flop-enhancing agents include unsubstituted indanthrone and indanthrone which is mono- or di-substituted by one or more substituents selected from the group consisting of halogen, —NR₁R₂, C₁-C₁₀alkyl and —X—NR_{1′}R_{2′}, wherein R₁ and R₂ are independently hydrogen, C₁-C₁₀alkyl or —NR_{1′}R_{2′}, R_{1′} and R_{2′} are independently hydrogen or C₁-C₁₀alkyl, and X is C₁-C₁₀alkylene.

Particularly suitable carbazole dioxazine compounds include C.I. Pigment Violet 23 and its derivatives. The carbazole dioxazine compounds are believed to be compounds of the formula

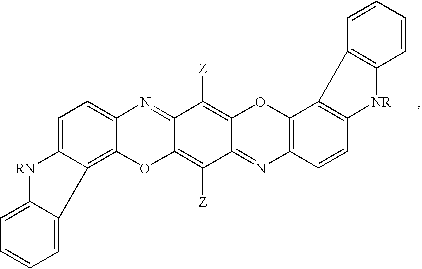

wherein each R is independently hydrogen or C₁-C₆alkyl, especially wherein each R is ethyl, Z is hydrogen or halogen, especially wherein each Z is halogen, especially chlorine, and the benzene rings are unsubstituted or substituted by one or more substituents selected from the group consisting of halogen, —NR₁R₂, C₁-C₁₀alkyl and —X—NR_{1′}R_{2′}, wherein R₁ and R₂ are independently hydrogen, C₁-C₁₀alkyl or —X—NR_{1′}R_{2′}, R_{1′} and R_{2′} are independently hydrogen or C₁-C₁₀alkyl, and X is C₁-C₁₀alkylene.

The benzene rings are unsubstituted or substituted by 1 to 2 substituents. Most preferably the benzene rings are unsubstituted or substituted by one substituent.

Preferred carbazole dioxazine flop-enhancing agents include unsubstituted carbazole dioxazine and carbazole dioxazine which is substituted by one or more substituents selected from the group consisting of halogen, —NR₁R₂, C₁-C₁₀alkyl and —X—NR_{1′}R_{2′}, wherein R₁ and R₂ are independently hydrogen, C₁-C₁₀alkyl or —X—NR_{1′}R_{2′}, R_{1′} and R_{2′} are independently hydrogen or C₁-C₁₀alkyl, and X is C₁-C₁₀alkylene.

The above-described unsubstituted copper phthalocyanine, indanthrone and carbazole dioxazine compounds are commercially available and are prepared by methods known in the art. Some of the above-described substituted compounds are also commercially available, for example, the halogenated copper phthalocyanine compounds such as mono chloro, trichloro, tetra chloro, per chloro (Pigment Green 7), per chloro bromo (Pigment Green 36).

A small particle size pigment is any pigment having a specific surface area in the range from 40 to 100 m²/g. Preferably, the small particle size pigment is a pigment having a specific surface area in the range from 50 to 90 m²/g, in particular from 60 to 80 m²/g. Pigments having a specific surface area within any of the above-described ranges are referred to as particle size-optimized pigments throughout this application. The surface area is measured by any acceptable method, preferably the BET method.

In general, pigments having a surface area within the above-indicated ranges are referred to as transparent pigments due to their lack of light scattering.

Highly saturated, small particle size pigments are preferred for metallized automotive coatings.

Preferably, the small particle size pigment is a 1,4-diketo-3,6-diaryl-pyrrolo[3,4-c]pyrrole (DPP), quinacridone, quinacridonequinone or a solid solution pigment. Preferred solid solution pigments are those which contain one or more 1,4-diketo-3,6-diaryl-pyrrolo[3,4-c]pyrrole, quinacridone and/or quinacridonequinone components.

Suitable 1,4-diketo-3,6-diaryl-pyrrolo[3,4-c]pyrrole pigments are well known in the art. Such suitable 1,4-diketo-3,6-diaryl-pyrrolo[3,4-c]pyrrole pigments include in particular particle size optimized compounds of the formula (I) or (II),

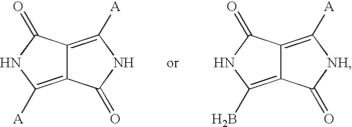

in which A and B are independently of each other a group of the formula

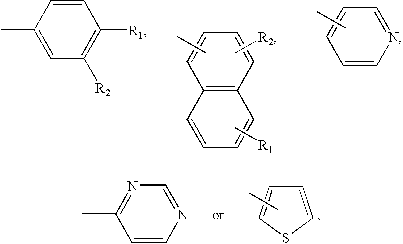

in which R₁ and R₂ are independently of each other hydrogen, halogen, C₁-C₅alkyl, C₁-C₅alkoxy, —SR₃, —N(R₃)₂, —CF₃, —CN or a group of the formula

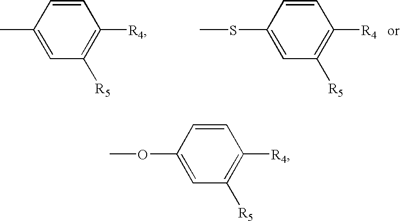

R₃ is C₁-C₅alkyl and R₄ and R₅ are independently of each other hydrogen, halogen, C₁-C₅alkyl, C₁-C₅alkoxy, —SR₃ or —CN.

Preferred diaryldiketopyrrolo[3,4-c]pyrroles are compounds of the formula (I) in which both A substituents are identical groups of the formula

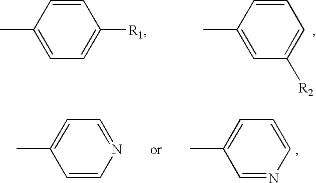

in which R₁ is hydrogen, chlorine, bromine, cyano, methyl, ethyl, tert-butyl or phenyl and R₂ is chlorine, methyl or cyano.

Preferred 1,4-diketo-3,6-diaryl-pyrrolo[3,4-c]pyrrole pigments include particle size optimized 1,4-diketo-3,6-diphenyl-pyrrolo[3,4-c]pyrrole, 1,4-diketo-3,6-di(4-chlorophenyl)-pyrrolo[3,4-c]pyrrole, 1,4-diketo-3,6-di(4-tert-butylphenyl)-pyrrolo[3,4-c]pyrrole, 1,4-diketo-3,6-di(3-cyanophenyl)-pyrrolo[3,4-c]pyrrole, 1,4-diketo-3,6-di(4-cyanophenyl)-pyrrolo[3,4-c]pyrrole, 1,4-diketo-3,6-di(biphenyl-1-yl)-pyrrolo[3,4-c]pyrrole, 1,4-diketo-3,6-di(4-methylphenyl)-pyrrolo[3,4-c]pyrrole and 1,4-diketo-3,6-di(3,4-dichlorophenyl)-pyrrolo[3,4-c]pyrrole.

Suitable quinacridone pigments are known in the art. Such suitable quinacridone pigments include particle size optimized linear quinacridone compounds of the formula

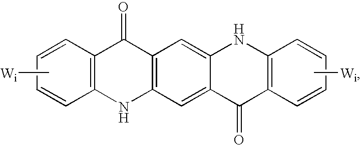

in which each W is independently of each other, halogen, C₁-C₅alkyl or C₁-C₅alkoxy and i is 0, 1 or 2.

Especially suitable quinacridone pigments include particle size optimized unsubstituted quinacridone, such as β-quinacridone, γ-quinacridone, 2,9-dichloroquinacridone and 2,9-dimethylquinacridone.

Suitable quinacridonequinone pigments are known in the art. Such quinacridonequinone pigments include particle size optimized compounds of the formula

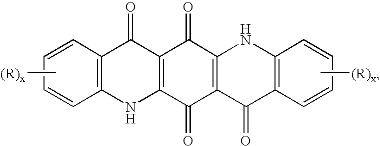

in which R is hydrogen, halogen or C₁-C₄alkyl, and x is 0, 1 or 2.

Especially suitable quinacridonequinone pigments include particle size optimized unsubstituted quinacridonequinone, 2,9-dichloroquinacridonequinone and 2,9-dimethylquinacridonequinone.

Particle size-optimized solid solution pigments are also suitable as the small particle size pigment of the present compositions. Any solid solution pigment with the proper particle size and sufficient saturation is suitable as the small particle size pigment. Particularly, suitable solid solution pigments are those which contain a 1,4-diketo-3,6-diaryl-pyrrolo[3,4-c]pyrrole, quinacridone or quinacridonequinone as a component of the solid solution. In particular, suitable solid solution pigments include particle size-optimized pigments of the type described in U.S. Pat. No. 4,286,998, U.S. Pat. No. 4,810,304, U.S. Pat. No. 4,783,540, U.S. Pat. No. 5,457,203, U.S. Pat. No. 5,472,496 and U.S. Pat. No. 5,529,623, which are here incorporated by reference.

Particularly suitable solid solution pigments include particle size optimized 2,9-dichloroquinacridone/1,4-diketo-3,6-di(4-chlorophenyl)-pyrrolo[3,4-c]pyrrole and 2,9-dichloroquinacridone/1,4-diketo-3,6-diphenyl-pyrrolo[3,4-c]pyrrole/1,4-diketo-3,6-di(4-chlorophenyl)-pyrrolo[3,4-c]pyrrole solid solutions.

In general, the pigment compositions are prepared by methods known in the art, for example by conventional wet blending techniques. Preferably, a slurry containing the small-particle-size pigment and the flop-enhancing agent is mixed until homogeneous. The pigment composition is then isolated by filtering the slurry.

The present pigment compositions contain from 0.1 to 10% by weight, based on the weight of the composition, of the flop-enhancing agent. Preferably, the pigment compositions contain from 2 to 6% by weight of the flop-enhancing agent. Most preferably, the pigment compositions contain 3 to 5% by weight of the flop-enhancing agent.

The present pigment compositions may also contain mixtures of more than one flop-enhancing agent selected from the group consisting of halogenated copper phthalocyanines, indanthrones and carbazole dioxazines. In particular, combinations where at least one flop-enhancing agent is a halogenated copper phthalocyanine that is unsubstituted or substituted in the benzene rings by —NR₁R₂, C₁-C₁₀alkyl and —X—NR_{1′}R_{2′}, wherein R₁ and R₂ are independently hydrogen, C₁-C₁₀alkyl or —X—NR_{1′}R_{2′}, R_{1′} and R_{2′} are independently hydrogen or C₁-C₁₀alkyl, and X is C₁-C₁₀alkylene and an indathrone or an carbazole dioxazine as described above are preferred.

For example, a halogenated copper phthalocyanine combined with an indanthrone or a halogenated copper phthalocyanine combined with a carbazole dioxazine is preferred.

Alternatively, mixtures of all three flop-enhancing agents selected from the group consisting of halogenated copper phthalocyanines, indanthrones and carbazole dioxazines are also preferred.

In addition to the small particle size pigment and the flop-enhancing agent, the present pigment compositions advantageously also contain customary additives.

In particular, the present pigment compositions contain a rheology improving agents in addition to the small particle size pigment and the flop-enhancing agent. Such rheology improving agents are known in the art and include pyrazolylmethyl-substituted quinacridones, pyrazolylmethyl-substituted-1,4-diketo-3,6-diaryl-pyrrolo[3,4-c]pyrroles, quinacridone sulfonic acids and/or their salts, 1,4-diketo-3,6-diaryl-pyrrolo[3,4-c]pyrrole sulfonic acids and/or their salts, N,N-dialkylquinacridonesulfonamides, phthalimidomethylquinacridones, phthalimidomethyl-1,4-diketo-3,6-diaryl-pyrrolo[3,4-c]pyrroles and mixtures thereof. Suitable rheology improving agents include pyrazolylmethylquinacridone, aluminum quinacridone monosulfonate and mixtures thereof.

In general, the present pigment compositions contain from 0 to 10% by weight of the rheology improving agent, based on the weight of the pigment composition. Preferably, the pigment compositions contain from 2 to 6% by weight of the rheology improving agent. Especially preferred pigment compositions contain from 3 to 5% by weight of the rheology improving agent.

The present pigment compositions are useful for preparing transparent coatings, in particular, industrial coatings and automotive finishes. Generally, an effective pigmenting amount of the pigment composition is incorporated into the coating composition to be pigmented, in particular by ball-milling and attritor grinding techniques. An effective pigmenting amount is any amount suitable to provide the desired color in the coating composition. In particular, the pigment compositions are used in an amount of 0.01 to 30% by weight, preferably 0.1 to 10% by weight, based on the weight of the coating composition to be pigmented.

Although it is preferred to pigment the coating composition with a pigment composition described above, pigmented coating compositions of the present invention are also prepared by incorporating the small particle size pigment and the flop-enhancing agent into the coating composition separately. If the small particle size pigment and flop-enhancing agent are incorporated into the coating composition separately, it is preferred to add them to the coating composition in slurry form.

In general, the coating compositions which are colored according to the present process contain a high-molecular-weight organic material which is, for example, a cellulose ether, a cellulose ester, a polyurethane, a polyester, a polycarbonate, a polyolefin, a polystyrene, a polysulfone, a polyamide, a polycycloamide, a polyimide, a polyether, a polyether ketone, a polyvinyl halide, a polytetrafluoroethylene, an acrylic or methacrylic polymer, a rubber, a silicone polymer, a phenol/formaldehyde resin, melamine, a formaldehyde resin, a urea/formaldehyde resin, an epoxy resin, a diene rubber or a copolymer thereof.

Heat-curable coatings or cross-linking, chemically-reactive coatings, are also colored according to the present process. Examples of the pigmented, high-molecular-weight organic materials which are used in coatings include acrylic, alkyd, epoxy, phenolic, melamine, urea, polyester, polyurethane, blocked isocyanate, benzoguanamine or cellulose ester resins, or combinations thereof. The pigmented coating compositions prepared according to the present process are also useful as air-drying or physically-drying coatings, for example, conventional lacquers such as those used in the cosmetics industry as nail varnishes, for example nitrocellulose lacquers.

The present process is particularly suitable for preparing industrial coatings and those conventionally employed in the automobile industry, especially in thermosetting resins such as acrylic/melamine resin, alkyd/melamine resin or thermoplastic acrylic resin systems, as well as in aqueous-based coating systems. The present pigment compositions are especially suitable for coloring solvent-borne and water-borne automotive finishes.

The present pigment compositions are especially useful in effect pigments, such as coated and uncoated micas, aluminum flakes, multilayered color shifting flake pigments and graphite flakes. Objects coated with a coating composition, which utilizes an effect pigment containing a pigment composition of the present invention, show a unique “flop” effect wherein a different color is observed when the object is viewed from different angles. Such a flop effect is often highly desirable in automotive finishes.

For example, a coating composition comprising an effect pigment, a small particle size pigment and at least one flop-enhancing agent selected from the group consisting of optionally substituted halogenated copper phthalocyanine, indanthrone and carbazole dioxazine is preferred. The inventive coating compositions can comprise a mixture of flop-enhancing agents selected from the group consisting of optionally substituted halogenated copper phthalocyanine, indanthrone and carbazole dioxazine.

Depending on the end use, it can be advantageous to add specific amounts of texture improving agents to the pigment. Suitable texture improving agents are, in particular, fatty acids of not less than 18 carbon atoms, for example stearic or behenic acid or the amides or metal salts thereof, preferably calcium or magnesium salts, as well as plasticizers, waxes, resin acids such as abietic acid or metal salts thereof, colophonium, alkyl phenols or aliphatic alcohols such as stearyl alcohol or vicinal diols such as dodecane-1,2-diol, and also modified colophonium/maleate resins or fumaric acid/colophonium resins or polymeric dispersants. The texture improving agents are preferably added in amount of 0.1 to 30%, by weight, most preferably 2 to 15% by weight, based on the final product.

The following examples further describe but do not limit the invention. All parts and percentages are by weight unless otherwise specified.

### EXAMPLE 1

(a) 4.0 g of 1,4-diketo-3,6-di(4-chlorophenyl)-pyrrolo[3,4-c]pyrrole, 6.0 g of 2,9-dichloroquinacridone, 1.0 g of dimethyl glutarate, 0.5 g of surfactant and 40 g of hydrated aluminum sulfate are combined in a 1000 ml ball mill containing steel balls and nails as grinding media. The ball mill is then rolled for about 24 hours. The contents are then discharged and separated from the milling media to yield a mill powder. The mill powder is stirred with 500 ml of 2% sulfuric acid at 90° C. for 2 hours. The resulting pigment slurry is then filtered and washed with hot water until neutral and free of salts to yield a small particle size solid solution pigment presscake.

(b) A mixture containing 99 parts of the above prepared presscake and 1.0 part of perchlorinated copper phthalocyanine (Pigment Green 7), the parts being based on dry weights, is slurried in water and mixed until homogeneous. The resulting pigment slurry is filtered, dried and pulverized to yield a pigment composition of the present invention.

(c) 16.5 g of the inventive pigment composition prepared above is combined with 41.2 g of polyurethane resin, 9.0 g of a dispersant resin and 98.3 g of a solvent thinner in a pint jar. The mixture is milled for 64 hours with 980 g of milling media to yield a pigment base containing 10% pigment and 30% solids at a binder ratio of 0.5.

### EXAMPLE 2

(a) A mixture containing 91.0 parts of the presscake prepared according to example 1(a), 4.0 parts of pyrazolylmethyl quinacridone and 4.0 parts of the aluminum salt of quinacridone monosulfonic acid, the parts being based on dry weights, is slurried in water and mixed with a slurry containing 1.0 part of perchlorinated copper phthalocyanine (Pigment Green 7). The resulting pigment slurry is filtered, dried and pulverized to yield a pigment composition of the present invention.

(b) A pigment base is prepared using the inventive pigment composition of step (a) by following the procedure described in example 1(c).

### EXAMPLE 3

(a) A mixture containing 90.0 parts of the presscake prepared according to example 1(a), 4.0 parts of pyrazolylmethyl quinacridone and 4.0 parts of the aluminum salt of quinacridone monosulfonic acid, the parts being based on dry weights, is slurried in water and mixed with a slurry containing 2.0 parts of perchlorinated copper phthalocyanine (Pigment Green 7). The resulting pigment slurry is filtered, dried and pulverized to yield a pigment composition of the present invention.

(b) A pigment base is prepared using the inventive pigment composition of step (a) by following the procedure described in example 1(c).

### EXAMPLE 4

(a) A mixture containing 89.0 parts of the presscake prepared according to example 1(a), 4.0 parts of pyrazolylmethyl quinacridone and 4.0 parts of the aluminum salt of quinacridone monosulfonic acid, the parts being based on dry weights, is slurried in water and mixed with a slurry containing 3.0 parts of perchlorinated copper phthalocyanine (Pigment Green 7). The resulting pigment slurry is filtered, dried and pulverized to yield a pigment composition of the present invention.

(b) A pigment base is prepared using the inventive pigment composition of step (a) by following the procedure described in example 1(c).

### EXAMPLE 5

(a) A mixture containing 90.0 parts of the presscake prepared according to example 1(a), 4.0 parts of pyrazolylmethyl quinacridone and 4.0 parts of the aluminum salt of quinacridone monosulfonic acid, the parts being based on dry weights, is slurried in water and mixed with a slurry containing 1.0 part of perchlorinated copper phthalocyanine (Pigment Green 7) and 1.0 part of unchlorinated copper phthalocyanine. The resulting pigment slurry is filtered, dried and pulverized to yield a pigment composition of the present invention.

(b) A pigment base is prepared using the inventive pigment composition of step (a) by following the procedure described in example 1(c).

### EXAMPLE 6

(a) A mixture containing 90.0 parts of the presscake prepared according to example 1(a), 4.0 parts of pyrazolylmethyl quinacridone and 4.0 parts of the aluminum salt of quinacridone monosulfonic acid, the parts being based on dry weights, is slurried in water and mixed with a slurry containing 1.0 part of perchlorinated copper phthalocyanine (Pigment Green 7) and 1.0 parts of phthalimidomethyl copper phthalocyanine. The resulting pigment slurry is filtered, dried and pulverized to yield a pigment composition of the present invention.

(b) A pigment base is prepared using the inventive pigment composition of step (a) by following the procedure described in example 1(c).

### EXAMPLE 7

(a) A mixture containing 90.0 parts of the presscake prepared according to example 1(a), 4.0 parts of pyrazolylmethyl quinacridone and 4.0 parts of the aluminum salt of quinacridone monosulfonic acid, the parts being based on dry weights, is slurried in water and mixed with a slurry containing 1.0 part of perchlorinated copper phthalocyanine (Pigment Green 7) and 1.0 part of N-(3-dimethylaminopropyl) copper phthalocyanine monosulfonamide. The resulting pigment slurry is filtered, dried and pulverized to yield a pigment composition of the present invention.

(b) A pigment base is prepared using the inventive pigment composition of step (a) by following the procedure described in example 1(c).

### EXAMPLE 8

(a) A mixture containing 90.0 parts of the presscake prepared according to example 1(a), 4.0 parts of pyrazolylmethyl quinacridone and 4.0 parts of the aluminum salt of quinacridone monosulfonic acid, the parts being based on dry weights, is slurried in water and mixed with a slurry containing 1.0 part of perchlorinated copper phthalocyanine (Pigment Green 7) and 1.0 parts of dimethylaminomethyl copper phthalocyanine. The resulting pigment slurry is filtered, dried and pulverized to yield a pigment composition of the present invention.

(b) A pigment base is prepared using the inventive pigment composition of step (a) by following the procedure described in example 1(c).

### EXAMPLE 9

(a) A mixture containing 89.0 parts of the presscake prepared according to example 1(a), 4.0 parts of pyrazolylmethyl quinacridone and 4.0 parts of the aluminum salt of quinacridone monosulfonic acid, the parts being based on dry weights, is slurried in water and mixed with a slurry containing 3.0 parts of perchlorinated copper phthalocyanine (Pigment Green 7). The resulting pigment slurry is filtered, dried and pulverized to yield a pigment composition of the present invention.

(b) A pigment base is prepared using the inventive pigment composition of step (a) by following the procedure described in example 1(c).

### EXAMPLE 10

(a) 10.0 g of 1,4-diketo-3,6-di(biphenyl-1-yl)-pyrrolo[3,4-c]pyrrole, 1.0 g of dimethyl glutarate, 0.5 g of surfactant and 40 g of hydrated aluminum sulfate are combined in a 1000 ml ball mill containing steel balls and nails as grinding media. The ball mill is then rolled for about 24 hours. The contents are then discharged and separated from the milling media to yield a mill powder. The mill powder is stirred with 500 ml of 2% sulfuric acid at 90° C. for 2 hours. The resulting pigment slurry is then filtered and then washed with hot water until neutral and free of salts to yield a small particle size pigment presscake.

(b) A mixture containing 95.0 parts of the presscake prepared according to example 10(a) and 4.0 parts of pyrazolylmethyl quinacridone, the parts being based on dry weights, is slurried in water and mixed with a slurry containing 1.0 part of perchlorinated copper phthalocyanine (Pigment Green 7). The resulting pigment slurry is filtered, dried and pulverized to yield a pigment composition of the present invention.

(c) A pigment base is prepared using the inventive pigment composition of step (a) by following the procedure described in example 1(c).

### EXAMPLE 11

(a) A mixture containing 94.0 parts of the presscake prepared according to example 10(a) and 4.0 parts of pyrazolylmethyl quinacridone, the parts being based on dry weights, is slurried in water and mixed with a slurry containing 2.0 parts of perchlorinated copper phthalocyanine (Pigment Green 7). The resulting pigment slurry is filtered, dried and pulverized to yield a pigment composition of the present invention.

(b) A pigment base is prepared using the inventive pigment composition of step (a) by following the procedure described in example 1(c).

### EXAMPLE 12

(a) 2.5 g of unsubstituted quinacridone, 7.5 g of 2,9-dichloroquinacridone, 1.0 g of dimethyl glutarate, 0.5 g of surfactant and 40 g of hydrated aluminum sulfate are combined in a 1000 ml bail mill containing steel balls and nails as grinding media. The ball mill is then rolled for about 24 hours. The contents are then discharged and separated from the milling media to yield a mill powder. The mill powder is stirred with 500 ml of 2% sulfuric acid at 90° C. for 2 hours. The resulting pigment slurry was then filtered and then washed with hot water until neutral and free of salts to yield a small particle size solid solution pigment presscake.

(b) A mixture containing 90.0 parts of the presscake prepared according to example 12(a), 4.0 parts of aluminum quinacridone monosulfonate and 4.0 parts of pyrazolylmethyl quinacridone, the parts being based on dry weights, is slurried in water and mixed with a slurry containing 2.0 parts of perchlorinated copper phthalocyanine (Pigment Green 7). The resulting pigment slurry is filtered, dried and pulverized to yield a pigment composition of the present invention.

(c) A pigment base is prepared using the inventive pigment composition of step (a) by following the procedure described in example 1(c).

### EXAMPLE 13

(a) 3.2 g of 1,4-diketo-3,6-diphenyl-pyrrolo[3,4-c]pyrrole, 2.0 g of 2,9-dichloroquinacridone, 4.8 g of 1,4-diketo-3,6-di(4-chlorophenyl)-pyrrolo[3,4-c]pyrrole, 1.0 g of dimethyl glutarate, 0.5 g of surfactant and 40 g of hydrated aluminum surface are combined in a 1000 ml ball mill containing steel balls and nails as grinding media. The ball mill is then rolled for about 24 hours. The contents are then discharged and separated from the milling media to yield a mill powder. The mill powder is stirred with 500 ml of 2% sulfuric acid at 90° C. for 2 hours. The resulting pigment slurry is then filtered and then washed with hot water until neutral and free of salts to yield a small particle size solid solution pigment presscake.

(b) A mixture containing 90.0 parts of the presscake prepared according to example 14(a), 4.0 parts of aluminum quinacridone monosulfonate and 4.0 parts of pyrazolylmethyl quinacridone, the parts being based on dry weights, is slurried in water and mixed with a slurry containing 2.0 parts of perchlorinated copper phthalocyanine (Pigment Green 7). The resulting pigment slurry is filtered, dried and pulverized to yield a pigment composition of the present invention.

(c) A pigment base is prepared using the inventive pigment composition of step (a) by following the procedure described in example 1(c).

### EXAMPLE 14

Aluminum Base:

An aluminum base is prepared by mixing 405 g of aluminum paste with 315 g of acrylic dispersion resin and 180 g of acrylic resin until lump-free.

Metallic Clear Solution:

A metallic clear solution is prepared by thoroughly mixing 1353 g of a non-aqueous dispersion resin, 786.2 g of melamine resin, 144.6 g of xylene, 65.6 g of an ultraviolet screener solution and 471.6 g of acrylourethane resin in the order given. 89.0 g of a premixed solution of acid catalyst and 90.0 g of methanol are then added with continued mixing.

Metallic Paint Formulation:

A basecoat paint is prepared by combining 46.8 g of the pigment base prepared in example 1(c), 4.2 g of aluminum base, 4.4 g of non-aqueous dispersion resin and 44.6 g of metallic clear solution to yield a paint composition containing 7.1% pigment and 54.4% solids with a pigment to binder ratio of 0.15.

Aluminum panels previously treated with a gray acrylic primer are sprayed with two coats of the basecoat paint to a film thickness of 15-20 μm and a dry film basis. The two sprayings are spaced by a 90 second flash at room temperature. After a flash of three minutes, two coats of an acrylic clear topcoat are applied to a thickness of 37-50 μm on a dry film basis. The panels are then dried for 10 minutes and baked at 120° C. for 30 minutes.

The coated panels exhibit a very attractive, intense color with excellent flop, high gloss and excellent distinctness of image.

### EXAMPLE 15

The procedure of example 14 is repeated replacing the pigment base of example 1(c) with the pigment bases prepared according to examples 2(b), 3(b), 4(b), 5(b), 6(b), 7(b), 8(b), 9(b), 10(c), 11(b), 12(c) and 13(c). In each instance, the coated panels exhibit a very attractive, intense color with excellent flop, high gloss and excellent distinctness of image. Within the series, the pigment base of example 4 exhibits outstanding metallic flop.

### EXAMPLE 16

Mica Base:

A mica base is prepared by mixing 251.1 g of russet mica with 315 g of acrylic dispersion resin until lump-free.

Mica Paint Formulation:

A mica paint formulation is prepared by combining 122.4 g of the pigment base prepared according to example 1(c), 70.2 g of mica base, 20.8 g of nonaqueous dispersion resin, 30.6 g of melamine resin, 2.6 g of ultraviolet screener and 3.5 g of catalyst. After shaking for 5 minutes, the final paint is prepared by diluting with xylene to a spray viscosity of 23 seconds.

Aluminum panels previously treated with a gray acrylic primer are sprayed with two coats of the basecoat paint to a film thickness of 15-20 μm and a dry film basis. The two sprayings are spaced by a 90 second flash at room temperature. After a flash of three minutes, two coats of an acrylic clear topcoat are applied to a thickness of 37-50 μm on a dry film basis. The panels are then dried for 10 minutes and baked at 120° C. for 30 minutes.

The coated panels exhibit a very attractive, intense color with excellent flop, high gloss and excellent distinctness of image.

### EXAMPLE 17

The procedure of example 16 is repeated replacing the pigment base of example 1(c) with the pigment bases prepared according to examples 2(b), 3(b), 4(b), 5(b), 6(b), 7(b), 8(b), 9(b), 10(c), 11(b), 12(c) and 13(c). In each instance, the coated panels exhibit a very attractive, intense color with high gloss and excellent distinctness of image. In general, metallic flop is more pronounced than the flop observed in examples 14 and 15. Within the series, the pigment base of example 4 exhibits outstanding metallic flop.

### EXAMPLE 18

Pigment Dispersion:

45.5 g of the pigment of example 5(a), 45.5 g of acrylic resin and 259.0 g of deionized water are combined in a 1000 ml attritor and stirred at 500 rpm for 15 to 20 hours to yield a pigment dispersion containing 13% pigment and 26% solids.

Aluminum Base:

An aluminum base is prepared by mixing 40.0 g of aluminum paste, 10.0 g of melamine resin and 50.0 g of butyl cellosolve until lump-free.

Waterborne Metallic Paint Formulation:

A waterborne basecoat paint is prepared by mixing 46.3 g of the pigment prepared above with 4.3 g of the aluminum base and a combination of 56.7 g of balancing clear and 45.8 g of compensating clear, which are mixtures of acrylic and melamine resins. The formulation corresponds to a pigment to binder ratio of 0.25.

Aluminum panels previously treated with gray acrylic primer are sprayed several times with the basecoat paint to an acceptable level of hiding. After the panels are dried, clearcoat is applied in two coats and dried.

The coated panels exhibit an attractive, intense color with excellent flop, high gloss and excellent distinctness of image.

### EXAMPLE 19

The procedure of example 18 is repeated replacing the pigment composition of example 5(a) with the pigment composition prepared according to examples 1(a), 2(a), 3(a), 4(a), 6(a), 7(a), 8(a), 9(a), 10(a), 11(a), 12(a) and 13(a). In each instance, the coated panels exhibit a very attractive, intense color with high gloss and excellent distinctness of image.

Flop Index Measurements:

The flop index is measured by using an XRITE MA 68 instrument. The paint evaluation was done in a HAPS (hazardous air pollutants) compliant BC/CC (base coat/clear coat) paint system.

Table I reveals the flop index results for various let downs.

TABLE I
XRITE MA 68 FLOP INDEX

| | 50/50 | | 50/50 |
|---|---|---|---|
| Let Down | aluminum | 85/15 aluminum | russet mica |
| ¹Pigment with flop | 12.67 | 11.21 | 16.21 |
| enhancing agent | | | |
| ¹Pigment without flop | 11.94 | 9.22 | 15.03 |
| enhancing agent | | | |
| ²Irgazin Red 179 | 11.26 | 8.98 | 12.0 |

¹Pigment is 2,9-dichloroquinacridone/di(4-chlorophenyl)-pyrrolo[3,4-c]pyrrole solid solution with pyrazolylmethyl quinacridone and aluminum salt of quinacridone monosulfonic acid. Flop enhancing agent is Pigment Green 7.
²Commercially available Perylene red pigment.

The results from the table above show the highest flop index for the pigment containing the flop enhancing agent(s) of the present invention. Surprisingly the flop index is significantly higher than the commercially established perylene, Irgazin Red 179 pigment.

Durability Assessments:

The pigment compositions of the present invention are extremely durable in commercially acceptable color stylings as shown in the following table. The durability assessments were done using an Atlas CI 65 Weather-o-meter at 1000, 2000 and 4000 hour time intervals and in 80/20 and 50/50 russet mica combinations. The comparative ΔE values are listed in Tables II and III.

TABLE II
Weather-o-meter Exposure Results (Let down: 80/20 Russet mica)

| | 1000 hours | 2000 hours | 4000 hours |
|---|---|---|---|
| Sample | ΔE | ΔE | ΔE |
| ¹Pigment with flop | 0.4 | 0.8 | 0.6 |
| enhancing agent | | | |
| ¹Pigment without flop | 0.8 | 1.2 | 1.0 |
| enhancing agent | | | |
| ²Irgazin Red 179 | 0.6 | 0.5 | 0.6 |

¹Pigment is 2,9-dichloroquinacridone/di(4-chlorophenyl)-pyrrolo[3,4-c]pyrrole solid solution pyrazolylmethyl quinacridone and aluminum salt of quinacridone monosulfonic acid. Flop enhancing agent is Pigment Green 7.
²Commercially available Perylene red pigment.

TABLE III
Weather-o-meter Exposure Results (Let down: 50/50 Russet mica)

| | 1000 hours | 2000 hours | 4000 hours |
|---|---|---|---|
| Sample | ΔE | ΔE | ΔE |
| ¹Pigment with flop | 0.5 | 0.5 | 0.7 |
| enhancing agent | | | |
| ¹Pigment without flop | 0.9 | 0.4 | 0.6 |
| enhancing agent | | | |
| ²Irgazin Red 179 | 0.7 | 0.5 | 0.7 |

¹Pigment is 2,9-dichloroquinacridone/di(4-chlorophenyl)-pyrrolo[3,4-c]pyrrole solid solution with pyrazolylmethyl quinacridone and aluminum salt of quinacridone monosulfonic acid. Flop enhancing agent is Pigment Green 7.
²Commercially available Perylene red pigment.

In another comparison the durability was assessed by the South Florida exposure series. The pigment of the present invention is durable enough to be a commercial pigment whereas the pigment of the prior art although has the unique flop (U.S. Pat. No. 5,618,343) ,is deficient as an automotive pigment.

TABLE IV
Two Year South Florida Exposure

| | 80/20 Aluminum | 50/50 Russet Mica |
|---|---|---|
| Sample | ΔE | ΔE |
| ¹Prior Art Pigment | 3.2 | 3.4 |
| (U.S. Pat. No. 5,618,343) | | |
| ²Pigment with New flop | 1.6 | 0.6 |
| enhancing agent | | |
| Pigment without flop | 1.9 | 0.6 |
| enhancing agent | | |

¹Pigment is 2,9-dichloroquinacridone/di(4-chlorophenyl)-pyrrolo[3,4-c]pyrrole solid solution pyrazolylmethyl quinacridone and aluminum salt of quinacridone monosulfonic acid. Flop enhancing agent is copper phthalocyanine monosulfonic acid.
²Pigment is 2,9-dichloroquinacridone/di(4-chlorophenyl)-pyrrolo[3,4-c]pyrrole solid solution with pyrazolylmethyl quinacridone and aluminum salt of quinacridone monosulfonic acid. Flop enhancing agent is Pigment Green 7.
³Pigment is 2,9-dichloroquinacridone/di(4-chlorophenyl)-pyrrolo[3,4-c]pyrrole solid solution pyrazolylmethyl quinacridone and aluminum salt of quinacridon monosulfonic acid.

The data above supports the invention that the perchlorinated phthalocyanines either alone or in combination with other compounds mentioned therein act as an excellent flop enhancing agent yet retains the durability characteristics required for an automotive pigment. The pigments of the present invention are equal to or better than the commercially established perylene pigments both in their flop behavior and their durability properties.

In addition to the embodiments described above, numerous variations of these embodiments can be made in accordance with this invention.

1. A coating composition comprising an effect pigment, a small particle size pigment and at least one flop-enhancing agent selected from the group consisting of optionally substituted halogenated copper phthalocyanines, indanthrones and carbazole dioxazines.

2. A coating composition of claim 1, wherein the composition comprises mixtures having more than one flop-enhancing agent selected from the group consisting of optionally substituted halogenated copper phthalocyanines, indanthrones and carbazole dioxazines.

3. A coating composition of claim 1, wherein at least one flop-enhancing agent is a halogenated copper phthalocyanine compound with one or more substituents selected from the group consisting of —NR₁R₂, C₁-C₁₀alkyl and —X—NR_{1′}R_{2′}, wherein R₁ and R₂ are independently hydrogen, C₁-C₁₀alkyl or —X—NR_{1′}R_{2′}, R_{1′} and R_{2′} are independently hydrogen or C₁-C₁₀alkyl, and X is C₁-C₁₀alkylene.

4. A coating composition of claim 3, wherein at least one flop-enhancing agent is an indanthrone with one or more substituents selected from the group consisting of halogen, —NR₁R₂, C₁-C₁₀alkyl and —X—NR_{1′}R_{2′}, wherein R₁ and R₂ are independently hydrogen, C₁-C₁₀alkyl or —NR_{1′}R_{2′}, R_{1′} and R_{2 ′} are independently hydrogen or C₁-C₁₀alkyl, and X is C₁-C₁₀alkylene.

5. A coating composition of claim 3, wherein at least one flop-enhancing agent is a carbazole dioxazine with one or more substituents selected from the group consisting of halogen, —NR₁R₂, C₁-C₁₀alkyl and —X—NR_{1′}R_{2′}, wherein R₁ and R₂ are independently hydrogen, C₁-C₁₀alkyl or —X—NR_{1′}R_{2′}, R_{1′} and R_{2′} are independently hydrogen or C₁-C₁₀alkyl, and X is C₁-C₁₀alkylene.

6. A coating composition of claim 1, comprising at least one halogenated copper phthalocyanine, an indanthrone and a carbazole dioxazine compound, each of which are unsubstituted or have one or more substituents selected from the group consisting of halogen, —NR₁R₂, C₁-C₁₀alkyl and —X—NR_{1′}R_{2′}, wherein R₁ and R₂ are independently hydrogen, C₁-C₁₀alkyl or —X—NR_{1′}R_{2′}, R_{1′} and R_{2′} are independently hydrogen or C₁-C₁₀alkyl, and X is C₁-C₁₀alkylene.

7. A coating composition of claim 1, wherein the small particle size pigment is a 1,4-diketo-3,6-diaryl-pyrrolopyrrole, a quinacridone, a quinacridonequinone or a solid solution pigment.

8. A coating compositions of claim 7, wherein the small particle size pigment is selected from the group consisting of β-quinacridone, 2,9-dichloroquinacridone, 2,9-dimethylquinacridone, 1,4-diketo-3,6-di(4-chlorophenyl)-pyrrolo[3,4-c]pyrrole, 1,4-diketo-3,6-di(biphenyl-1-yl)-pyrrolo[3,4-c]pyrrole, 2,9-dichloroquinacridone/1,4-diketo-3,6-di(4-chlorophenyl)-pyrrolo[3,4-c]pyrrole solid solution, and 2,9-dichloroquinacridone/1,4-diketo-3,6-diphenyl-pyrrolo[3,4-c]pyrrole/1,4-diketo-3,6-di(4-chlorophenyl)-pyrrolo[3,4-c]pyrrole solid solution of specific surface area from 40 to 100 m²/g, and at least one of the flop-enhancing agents is a halogenated copper phthalocyanine, indanthrone or carbazole dioxazine compound, wherein the benzene rings of the flop-enhancing agents are unsubstituted or substituted by one or more substituents selected from the group consisting of halogen, —NR₁R₂, C₁-C₁₀alkyl and —X—NR_{1′}R_{2′}, wherein R₁ and R₂ are independently hydrogen, C₁-C₁₀alkyl or —X—NR_{1′}R_{2′}, R_{1′} and R_{2′} are independently hydrogen or C₁-C₁₀alkyl, and X is C₁-C₁₀alkylene.

9. A coating composition of claim 8, wherein the small particle size pigment is a 2,9-dichloroquinacridone/1,4-diketo-3,6-di(4-chlorophenyl)-pyrrolo[3,4-c]pyrrole solid solution and at least one flop-enhancing agent is a halogenated copper phthalocyanine compound.

10. A pigment composition which comprises a transparent pigment and from 0.1 to 10% by weight, based on the weight of the composition, of at least one flop-enhancing agent selected from the group consisting of halogenated copper phthalocyanine, indanthrone or carbazole dioxazine compounds or mixtures thereof, wherein the benzene rings of the flop-enhancing indanthrone or carbazole dioxazine agents are unsubstituted or substituted by one or more substituents selected from halogen, —NR₁R₂, C₁-C₁₀alkyl and —X—NR_{1′}R_{2′}, wherein R₁ and R₂ are independently hydrogen, C₁-C₁₀alkyl or —X—NR_{1′}R_{2′}, R_{1′} and R_{2′} are independently hydrogen or C₁-C₁₀alkyl, and X is C₁-C₁₀alkylene.

11. A pigment composition of claim 10, wherein at least one flop-enhancing agent is a halogenated copper phthalocyanine wherein the benzene rings of the flop-enhancing agent are unsubstituted or substituted by one or more substituents selected from the group consisting of —NR₁R₂, C₁-C₁₀alkyl and —X—NR_{1′}R_{2′}, wherein R₁ and R₂ are independently hydrogen, C₁-C₁₀alkyl or —X—NR_{1′}R_{2′}, R_{1′} and R_{2′} are independently hydrogen or C₁-C₁₀alkyl, and X is C₁-C₁₀alkylene.

12. A pigment composition of claim 11, further comprising a second flop-enhancing agent, wherein the second flop-enhancing agent is an indanthrone, wherein the benzene ring of the flop-enhancing indanthrone is unsubstituted or substituted by one or more substituents selected from the group consisting of halogen, —NR₁R₂, C₁-C₁₀alkyl and —X—NR_{1′}R_{2′}, wherein R₁ and R₂ are independently hydrogen, C₁-C₁₀alkyl or —X—NR_{1′}R_{2′}, R_{1′} and R_{2′} are independently hydrogen or C₁-C₁₀alkyl, and X is C₁-C₁₀alkylene.

13. A pigment composition of claim 11, further comprising a second flop-enhancing agent wherein the second flop-enhancing agent is carbazole dioxazine, wherein the benzene ring of the flop-enhancing carbazole dioxazine is unsubstituted or substituted by one or more substituents selected from the group consisting of halogen, —NR₁R₂, C₁-C₁₀alkyl and —X—NR_{1′}R_{2′}, wherein R₁ and R₂ are independently hydrogen, C₁-C₁₀alkyl or —X—NR_{1′}R_{2′}, R_{1′} and R_{2′} are independently hydrogen or C₁-C₁₀alkyl, and X is C₁-C₁₀alkylene.

14. A pigment composition of claim 10, comprising a halogenated copper phthalocyanine, an indanthrone and at least one carbazole dioxazine compound flop-enhancing agents, wherein the benzene rings of the indanthrone and carbazole dioxazine flop-enhancing agents are unsubstituted or substituted by one or more substituents selected from the group consisting of halogen, —NR₁R₂, C₁-C₁₀alkyl and —X—NR_{1′}R_{2′}, wherein R₁ and R₂ are independently hydrogen, C₁-C₁₀alkyl or —X—NR_{1′}R_{2′}, R_{1′} and R_{2′} are independently hydrogen or C₁-C₁₀alkyl, and X is C₁-C₁₀alkylene, wherein the benzene ring of the halogenated copper phthalocyanine flop-enhancing agent is unsubstituted or substituted by one or more substituents selected from the group consisting of NR₁R₂, C₁-C₁₀alkyl and —X—NR_{1′}R_{2′}, wherein R₁ and R₂ are independently hydrogen, C₁-C₁₀alkyl or —X—NR_{1′}R_{2′}, R_{1′} and R_{2′} are independently hydrogen or C₁-C₁₀alkyl, and X is C₁-C₁₀alkylene.

15. A pigment composition of claim 10, wherein the transparent pigment is a 1,4-diketo-3,6-diaryl-pyrrolopyrrole, a quinacridone, a quinacridonequinone or a solid solution pigment.

16. A pigment composition of claim 10, further comprising an effect pigment.

17. A pigment composition of claim 15 wherein the transparent pigment is β-quinacridone, 2,9-dimethylquinacridone, 1,4-diketo-3,6-di(4-chlorophenyl)-pyrrolo[3,4-c]pyrrole, 1,4-diketo-3,6-di(biphenyl-1-yl)-pyrrolo[3,4-c]pyrrole, 2,9-dichloroquinacridone/1,4-diketo-3,6-di(4-chlorophenyl)-pyrrolo[3,4-c]pyrrole solid solution or 2,9-dichloroquinacridone/1,4-diketo-3,6-diphenyl-pyrrolo[3,4-c]pyrrole/1,4-diketo-3,6-di(4-chlorophenyl)-pyrrolo[3,4-c]pyrrole solid solution.

18. A pigment composition of claim 17, wherein the transparent pigment is a 2,9-dichloroquinacridone/1,4-diketo-3,6-di(4-chlorophenyl)-pyrrolo[3,4-c]pyrrole solid solution and the flop-enhancing agent is Pigment Green 7.

19. A pigment composition of claim 17, wherein the transparent pigment is 2,9-dichloroquinacridone/1,4-diketo-3,6-di(4-chlorophenyl)-pyrrolo[3,4-c]pyrrole solid solution and the flop-enhancing agent is Pigment Green 36.

20. A pigment composition of claim 15, which further comprises a rheology improving agent selected from the group consisting of pyrazolylmethylquinacridone, aluminum quinacridone monosulfonate and mixtures thereof.

21. A method of enhancing the flop of a polymeric coating containing an effect pigment and a transparent pigment, which comprises incorporating a flop-enhancing agent into the polymeric coating, wherein the flop-enhancing agent is selected from the group consisting of halogenated copper phthalocyanine, indanthrone or carbazole dioxazine compounds or mixtures thereof.

22. A coating composition of claim 1, wherein the effect pigment is selected from the group consisting of coated micas, uncoated micas, aluminum flakes, multilayered color shifting flake pigments, and graphite flakes.
